(19) United States
(12) Patent Application Publication
(10) Pub. No.: US 2008/0252567 A1
(43) Pub. Date: Oct. 16, 2008

(54) Active Matrix Display Device

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/066,494

(22) PCT Filed: Sep. 11, 2006
(86) PCT No.: PCT/US2006/035042

§ 371 Date: Mar. 19, 2008

(30) Foreign Application Priority Data
Sep. 21, 2005 (JP) 2005-274376

(51) Int. Cl. G09G 3/30

(52) U.S. Cl. 345/76

(57) ABSTRACT

An active matrix display device has a display section including a plurality of pixel sections each controlling the light intensity of an electro-optical element, a data driver supplying a data value to a data line, a gate driver supplying a selection signal to a gate line, and a controller. The controller includes a video data processing section that outputs video data to each pixel section, a correction data processing section that calculates and outputs correction data based on the video data supplied to each pixel section or its output history, and a multiplexer that selectively outputs the data. The video data is displayed during a predetermined video period, and the correction data is displayed during a predetermined correction period. The sum of the video period and the correction period is equal to the display period of one frame in the display section.

### FIELD OF THE INVENTION

The present invention generally relates to an active matrix display device, and more particularly to an active matrix display device including electroluminescence elements.

### BACKGROUND OF THE INVENTION

Because organic EL (Electro Luminescence) display devices are self-luminous and advantageous in terms of responsiveness, brightness, and wider viewing angle, many consider that organic EL display device will be adopted in the next generation of display devices. Especially, active matrix organic EL display devices can realize highly-accurate display and can be employed in a wide range of electronic devices, including portable terminals and large-screen television displays.

Organic EL display devices requires a drive element for controlling the current flowing across an organic EL element in order to control the light emission of the organic EL element that forms a pixel. A TFT (Thin Film Transistor) can be used as a drive element. Especially, a low-temperature polysilicon TFT has relatively high mobility and can operate speedily, and is stable for a relatively long time. Thus, the low-temperature polysilicon TFT is preferable as a drive element for driving an organic EL element.

Furthermore, practical trials of use of amorphous silicon TFTs as drive elements of an organic EL element have recently begun. Amorphous silicon TFTs are advantageous in low cost and large area.

The low-temperature polysilicon TFT and the amorphous silicon TFT have the following advantages and disadvantages. The low-temperature polysilicon TFT is highly stable and has excellent mobility, but shows poor uniformity in characteristics when used in a saturation region. On the other hand, the amorphous silicon TFT has excellent uniformity in characteristics, but is unstable and has relatively poor mobility.

When a plurality of low-temperature polysilicon TFTs are arranged to configure an organic EL display device, respective TFTs will have differences in brightness due to poor uniformity in their characteristics. Although it is theoretically possible to use the TFT as a switch for turning on and off each organic EL element to adjust the gradation and thereby improve uniformity, realizing such a control requires that a voltage be applied to the organic EL element, and increasing the activation time of the organic EL element to cause the element to emit brighter light will result in deterioration of the element. More specifically, due to undesirable increase in element resistance, image persistence (i.e. burn-in) appears on an image. Thus, the image quality is degraded.

On the other hand, when a plurality of amorphous silicon TFTs are arranged to configure an organic EL display device, no significant differences in brightness will be recognized because the amorphous silicon TFTs exhibit excellent uniformity even when used in a saturation region. However, the amorphous silicon TFT has poor stability and accordingly deteriorates when activated for a long time. Thus, image persistence appears and image quality is degraded.

Because of the above-described problems, suppressing the image persistence is essential in order to assure a long operational life for a display device regardless of the type of TFTs employed. Japanese Patent Application Laid-open No. 2003-228329, for example, discloses one technique for suppressing the image persistence.

Adjusting the gradation to correct the above adverse influence of image persistence requires appropriate setting of the dynamic range of a signal in advance considering both a video display region for displaying an image and a correction region for correcting the image. For example, when 5V is required for the video display region and another 5V is required for the correction region, 10V is required for the dynamic range. When 5V of the video display region is expressed as 8-bit data (i.e. 256 gradation levels), an estimated size for expressing 10V of the signal dynamic range including the correction region amounts to approximately 9 bits (i.e., 512 gradation levels).

Usually, such a bit (gradation) conversion requires a special or dedicated IC (Integrated Circuit). In other words, introducing the correcting function cannot be realized without developing a special or dedicated IC that can newly provide a wide dynamic range. The entire development cost will increase and, accordingly, the resulting IC will be expensive.

Moreover, according to a digitally driven display device, the correction processing tends to produce noises that are generally referred to as false contours and as a result the visibility is reduced markedly.

### SUMMARY OF THE INVENTION

In consideration of the above, the present invention provides an active matrix display device having self-luminous elements and solving one or more of the above-described problems.

The present invention provides a display device including a display section, a data driver, a gate driver, and a controller. The display section includes a plurality pairs of an electro-optical element and a pixel section which are disposed in a matrix pattern. The pixel section controls a light intensity of the electro-optical element based on a selection signal of a gate line and a data value of a data line. The data driver supplies the data value to the data line. The gate driver supplies the selection signal to the gate line. The controller includes a video data processing section, a correction data processing section, and a multiplexer. The video data processing section outputs video data to each pixel section in accordance with an externally entered video signal. The correction data processing section calculates and outputs correction data based on the video data supplied to each pixel section or based on output history of the video data, and the multiplexer selectively outputs the data in such a manner that the video data is displayed during a predetermined video period and the correction data is displayed during a predetermined correction period, wherein addition of the video period and the correction period is equal to a display period of one frame in the display section.

It is preferable that the electro-optical element is a light emitting element. For example, the electro-optical element can be constructed from a self-luminous electroluminescence element.

Furthermore, it is preferable that the pixel section includes a light emitting element, a drive transistor for controlling light emission of the light emitting element based on the data value supplied to the data line, and a gate transistor for controlling the data value of the data line supplied to the drive transistor based on the selection signal supplied to the gate line. With such a configuration, it is further preferable that the data value supplied to the data line includes data values for producing a plurality of current values from the drive transistor. For example, the data value supplied to the data line includes a data value for turning on the drive transistor and a data value for turning off the drive transistor.

Furthermore, it is preferable that the gate driver includes a plurality of shift registers, each provided for a predetermined line, for transferring selected data; a plurality of enable circuits, each provided for a predetermined line, for enabling the selected data; and a total of n (n is an integer greater than or equal to 2) enable control lines for controlling the enable circuits, wherein a group of enable circuits, disposed at intervals of n lines, are connected to a same enable control line. With such a configuration, it is further preferable that the gate driver selects a gate line by activating one non-active enable control line from the n enable control lines, when selected data are input to lines mutually different in a remainder resulting from a division of P/n, where P is a total number of gate lines, and the data driver outputs video data of the gate line selected by the enable control line.

Furthermore, it is preferable that the multiplexer outputs the video data produced from the video data processing section during the video period and outputs the correction data produced from the correction data processing section during the correction period. For example, the multiplexer outputs the video data produced from the video data processing section during a period selected, by the enable control line, for writing the video data. The multiplexer outputs the correction data produced from the correction data processing section during a period selected, by the enable control line, for writing the correction data.

Furthermore, it is preferable that selection and output of the multiplexer is performed in such a manner that a portion of the video data produced from the video data processing section is displayed during the video period and the remainder of the video data and the correction data produced from the correction data processing section are displayed during the correction period. Alternatively, it is preferable that selection and output of the multiplexer is performed in such a manner that a portion of the correction data produced from the correction data processing section is displayed during the correction period and the remainder of the correction data and the video data produced from the video data processing section are displayed during the video period.

Furthermore, it is preferable that the correction data processing section calculates a cumulative value of luminous intensity in each pixel section, and calculates the correction data for the pixel circuit with reference to the cumulative value. For example, it is preferable that the correction data processing section includes a volatile memory, each pixel section is classified into one of a plurality of updating order categories, and the cumulative value calculated for each pixel section is divided sequentially in time for each updating order category and stored in the volatile memory.

For example, it is preferable that the correction data processing section includes a volatile memory and a nonvolatile memory, and that the cumulative value calculated for each pixel section and stored in the volatile memory is renewed in the nonvolatile memory at timing different from the timing of the volatile memory. In a further example, it is preferable that the correction data processing section includes a volatile memory and a nonvolatile memory, and that at least one of the volatile memory and the nonvolatile memory is renewed based on a present luminous intensity of a pixel section and the cumulative value calculated for the pixel section when the luminous intensity is high and a light emission period is long in the pixel section.

Furthermore, it is preferable that the controller includes a current monitor for measuring a current value supplied to the display section, the video data processing section corrects the video data based on a measurement result of the current monitor, and the correction data processing section corrects the correction data based on the measurement result of the current monitor.

In a practical circuit arrangement, it is preferable that an anode of the light emitting element is connected to a first power line via a drain-source of the drive transistor, a cathode of the light emitting element is connected to a second power line, a gate of the drive transistor is connected via a drain-source of the gate transistor to the data line and also connected via a capacitor to the first power line, and a gate of the gate transistor is connected to the gate line.

Furthermore, it is preferable that an anode of the light emitting element is connected to a first power line, a cathode of the light emitting element is connected via a drain-source of the drive transistor to a second power line, a gate of the drive transistor is connected via a drain-source of the gate transistor to the data line and also connected via a capacitor to the first power line, and a gate of the gate transistor is connected to the gate line.

According to the present invention, an active matrix display device having self-luminous elements can adjust the gradation without causing deterioration of a displayed image resulting from image persistence (i.e., burn-in) of the display device. Thus, the display device of the present invention has a significantly longer service life than related devices.

The above and other objects, features, and advantages of the present invention will become more apparent from the following detailed description of exemplary embodiments with reference to the attached drawings

### BRIEF DESCRIPTION OF THE DRAWINGS

The accompanying drawings, which are incorporated in and constitute a part of the specification, illustrate embodiments of the invention and, together with the description, serve to explain the principles of the invention, in which:

FIG. 1 is a block diagram showing the overall configuration of an active matrix panel in accordance with a first embodiment of the present invention;

FIG. 2 is a circuit diagram showing a pixel circuit in accordance with the first embodiment of the present invention;

FIG. 3 is a schematic diagram showing a scanning operation of a digitally driven display device;

FIG. 4 is a circuit diagram showing a practical arrangement of a gate driver;

FIG. 5 is an enable timing chart in accordance with the first embodiment of the present invention;

FIG. 6A is a schematic diagram showing a conventional method for producing a gradation;

FIG. 6B is a schematic diagram showing a method for producing a gradation in accordance with the first embodiment of the present invention;

FIG. 7 is a block diagram showing functional blocks of a controller;

FIG. 8 is a functional block diagram showing a correction data processing section in accordance with the first embodiment of the present invention;

FIG. 9 is a diagram showing a method for storing history data by classifying respective pixels according to predetermined updating order categories;

FIG. 10 is a functional block diagram showing another correction data processing section in accordance with the first embodiment of the present invention;

FIG. 11A is a schematic view explaining a method for correcting image persistence;

FIG. 11B is a schematic view explaining the method for correcting image persistence;

FIG. 11C is a schematic view explaining the method for correcting image persistence;

FIG. 12A is a schematic view explaining a driving method in accordance with a second embodiment of the present invention;

FIG. 12B is schematic view explaining the driving method in accordance with the second embodiment of the present invention;

FIG. 13 is an enable timing chart in accordance with the second embodiment of the present invention;

FIG. 14A is a circuit diagram showing a pixel circuit in accordance with the second embodiment of the present invention;

FIG. 14B is a circuit diagram showing another pixel circuit in accordance with the second embodiment of the present invention; and

FIG. 15 is a functional block diagram showing a correction data processing section in accordance with a third embodiment of the present invention.

### DESCRIPTION OF PREFERRED EMBODIMENTS

Hereinafter, preferred embodiments of the present invention will be explained with reference to the attached drawings.

### First Embodiment

Image Persistence Correction

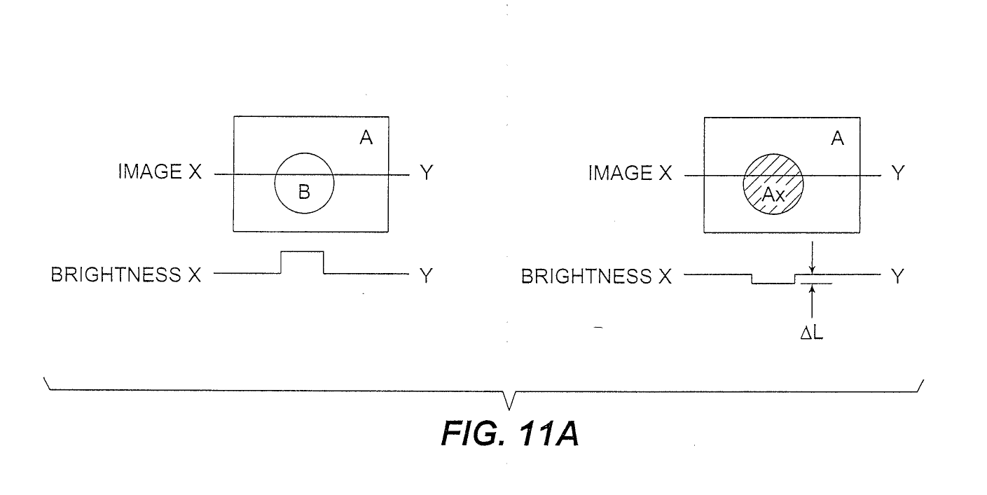

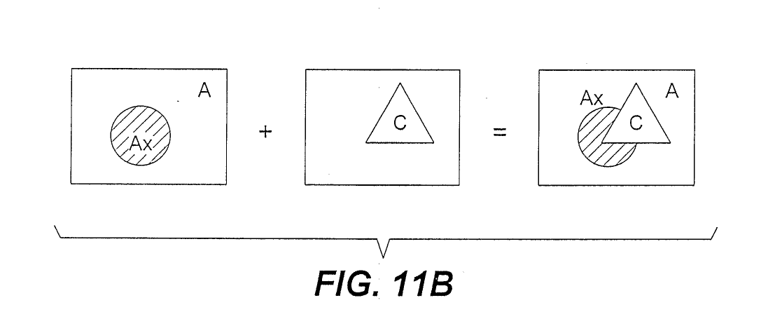

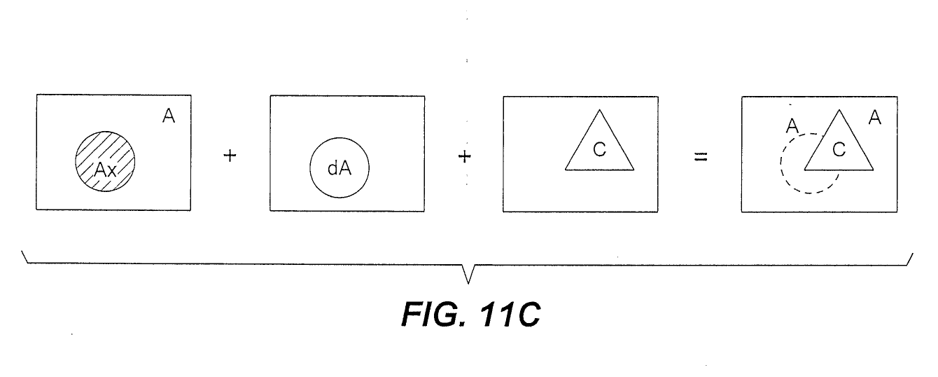

A general image persistence correction will be described with reference to FIGS. 11A, 11B, and 11C. An example will be discussed in which, as shown in FIG. 11A, an image A is displayed as a background while an image B brighter than the image A is superimposed on the image A. When the images A and B are displayed together for a relatively long time, an image Ax appears as an image whose brightness is undesirably reduced by ΔL. The image Ax is a portion in which the brightness of the image is reduced by ΔL, which is generally called as image persistence. Such image persistence is believed to occur when a light emitting efficiency of an organic EL element is decreased, or when a drive TFT is deteriorated. Furthermore, image persistence occurs when the current reduces due to a resistance increase in the organic EL element. For example, a digitally driven display device controls the voltage applied to the organic EL element for the gradation control. Thus, the digitally driven display device is subjected to such a resistance increase in the organic EL element.

Subsequently, as shown in FIG. 11B, a new image C is superimposed on the background image A. In this case, the image Ax remains as image persistence and accordingly the visibility of the image C is extremely lessened. Hence, as shown in FIG. 11C, a correction image dA is added to the image C to cancel the image persistence. More specifically, superimposing the correction image dA on the image Ax enables increasing the brightness by ΔL. As a result, the image persistence can be cancelled. As a result, visibility of the image C can be maintained.

### First Embodiment

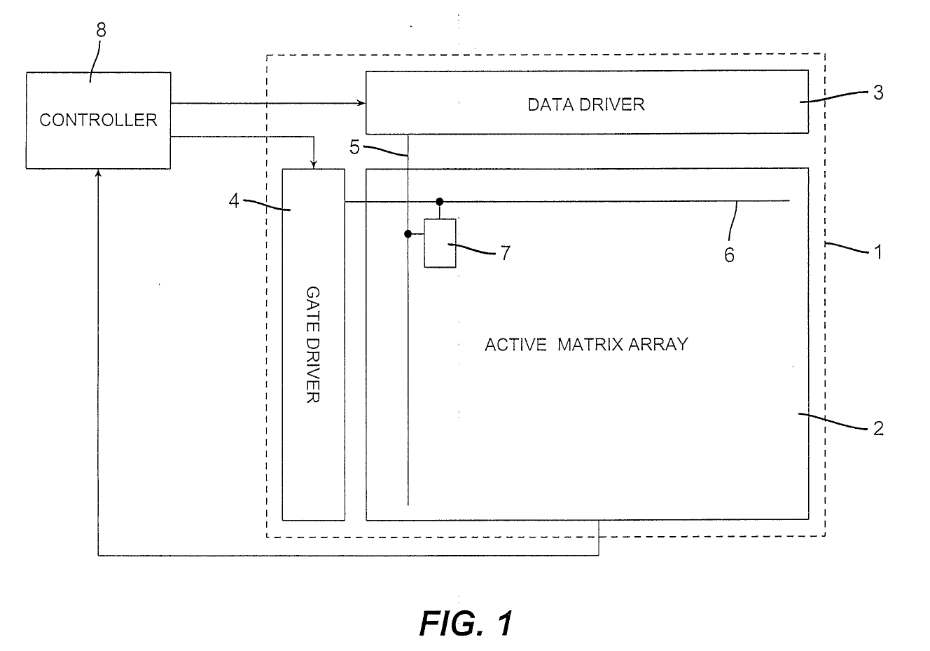

FIG. 1 shows the overall configuration of an active matrix display device in accordance with a first embodiment of the present invention. An active matrix display device 1 includes an active matrix array 2, a data driver 3, a gate driver 4, and a controller 8. The active matrix array 2 consists of a plurality of pixel circuits 7, each including an organic EL element, disposed in a predetermined matrix pattern. The data driver 3 controls an electric potential of each data line 5. The gate driver 4 controls an electric potential of each gate line 6. The controller 8 controls the data driver 3 and the gate driver 4. The gate driver 4 selects a gate line in response to a timing signal supplied from the controller 8. Data supplied from the data driver 3 is written into a pixel connected to the selected gate line. Thus, each pixel is controlled to have a desired luminous intensity. The current of the active matrix array 2 is fed back to the controller 8 to enable the controller 8 to monitor the current.

The active matrix array 2 is usually formed on a glass substrate. The data driver 3 and the gate driver 4, when they are constructed from low-temperature polysilicon TFTs, can be formed on the same glass substrate together with the active matrix array 2. When the data driver 3 and the gate driver 4 are constructed from amorphous silicon TFTs, the data driver 3 and the gate driver 4 can be integrated as an external IC (Integrated Circuit) that is connectable with the active matrix array 2.

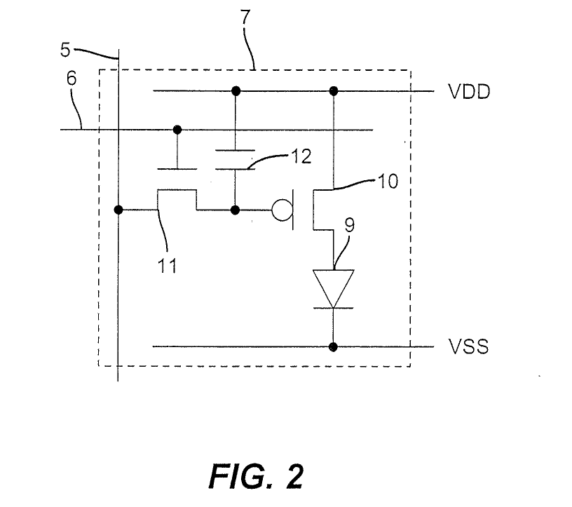

FIG. 2 shows an equivalent circuit of the pixel circuit 7. A drive transistor 10 has a source terminal connected to a power line common to all pixels. The power line is maintained at a voltage VDD. The drive transistor 10 has a drain terminal connected to an anode of an organic EL element 9. A gate terminal of the drive transistor 10 is connected to one end of a holding capacitor 12 and also connected to a source terminal of a gate transistor 11. The other end of the holding capacitor 12 is connected to the power line and accordingly maintained at the voltage VDD. A cathode of the organic EL element 9 is connected a VSS terminal common to all pixels. The VSS terminal is maintained at a voltage VSS.

The gate transistor 11 has a gate terminal connected to the gate line 6 and a drain terminal connected to the data line 5. When the gate line 6 is activated (i.e., is at a high level), data supplied from the data line 5 is written into the holding capacitor 12. When the gate line 6 is deactivated (i.e., is at a low level), the data is held in the holding capacitor 12 and the data is maintained until the gate line 6 is activated again.

When a voltage (i.e., ON voltage) sufficient for turning on the drive transistor 10 is supplied to the gate terminal of the drive transistor 10, VDD-VSS voltage is applied to the organic EL element 9 and the organic EL element 9 emits light. On the other hand, when a voltage (i.e., OFF voltage) sufficient for turning off the drive transistor 10 is supplied to the gate terminal of the drive transistor 10, no voltage is applied to the organic EL element 9 and the organic EL element 9 emits no light.

In a digitally driven display device, the above conditions are alternately switched according to video data to change or adjust a light emission period. Thus, the digitally driven display device can realize a gradational display according to the video data.

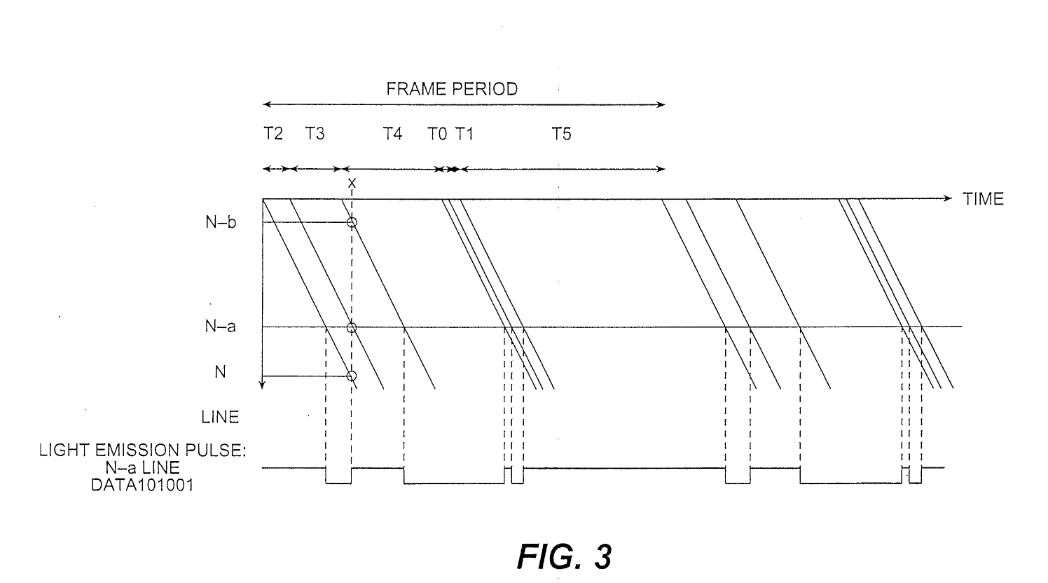

FIG. 3 is a timing chart showing an example of a scanning operation in a 6-bit digitally driven display device. One frame period is divided into six sub frames. The ratio of display periods T0 to T5 of respective sub frames is set to satisfy a relationship T0:T1:T2:T3:T4:T5=1:2:4:8:16:32. According to the example shown in FIG. 3, the scanning operation is performed in the order of T2, T3, T4, T0, T1, and T5.

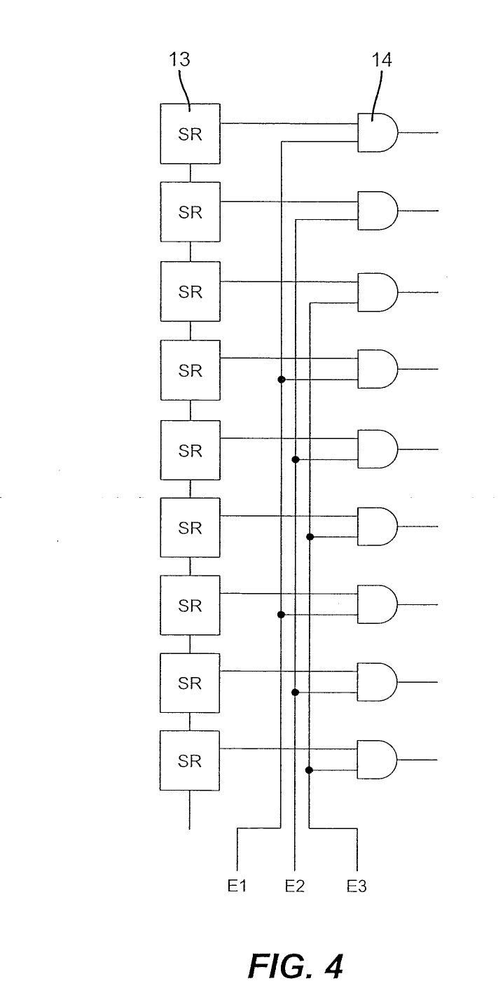

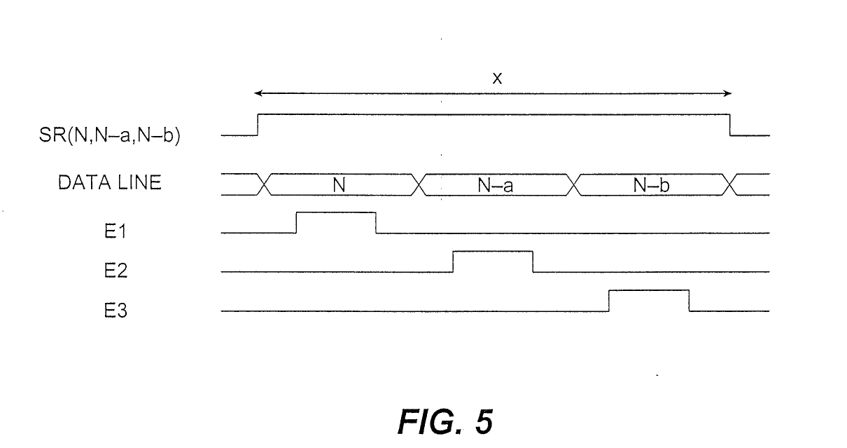

For example, the processing for a line N-a is performed in the following manner. When the display data of an arbitrary pixel on the N-a line is 101001 in the form of 6-bit data, a light emission pulse of the pixel is ON in the display periods T5, T3, and T0 and OFF in the display periods T4, T2, and T1, as shown in FIG. 3. In this case, obtainable brightness for the pixel is level 41 in the luminous intensity (when the maximum level is 63). In the duration X of FIG. 3, the line N begins with sub frame 2 (i.e., display period T2), the line N-a begins with sub frame 3 (i.e., display period T3), and the N-b line begins with sub frame 4 (i.e., display period T4). To accurately realize such a driving control, the gate driver has an arrangement shown in FIG. 4 and is controlled according to the timing chart shown in FIG. 5.

The gate driver shown in FIG. 4 includes a plurality of shift registers 13 connected in series. Each shift register 13 is connected to an enable circuit 14 that enables the data of the shift register 13. Three enable lines E1, E2, and E3 are provided for controlling the enable circuits 14. An output terminal of each enable circuit 14 is connected to a corresponding gate line. The enable line E1 is for controlling the enable circuits of lines 1, 4, - - - , 3*n+1. The enable line E2 is for controlling the enable circuits of lines 2, 5, - - - , 3*n+2. The enable line E3 is for controlling the enable circuits of lines 3, 6, - - - , 3*n+3 (wherein “n” is 0 or a positive integer).

In the duration X, the shift registers of the lines N, N-a, and N-b store the data “1” and the rest of the shift registers store the data “0”. With values “a” and “b” being appropriately set, the enable line E1 controls the line N (N=3*n+1), the enable line E2 controls the line N-a (N-a=3*n+2), and the enable line E3 controls the line N-b (N-b=3*n+3). For example, the values “a” and “b” can be set so as to satisfy N=199, N-a=134, and N-b=6. In this case, the enable line E1 controls the line N, the enable line E2 controls the line N-a, and the enable line E3 controls the line N-b.

As shown in FIG. 5, the data for the lines N, N-a, and N-b are successively output to the data line 5. The enable lines E1, E2, and E3 are successively activated in synchronism with the data of the data line 5. The data of the sub frame 2 for the line N is written into the line N. The data of the sub frame 3 for the line N-a is written into the line N-a. And, the data of the sub frame 4 for the line N-b is written into the line N-b.

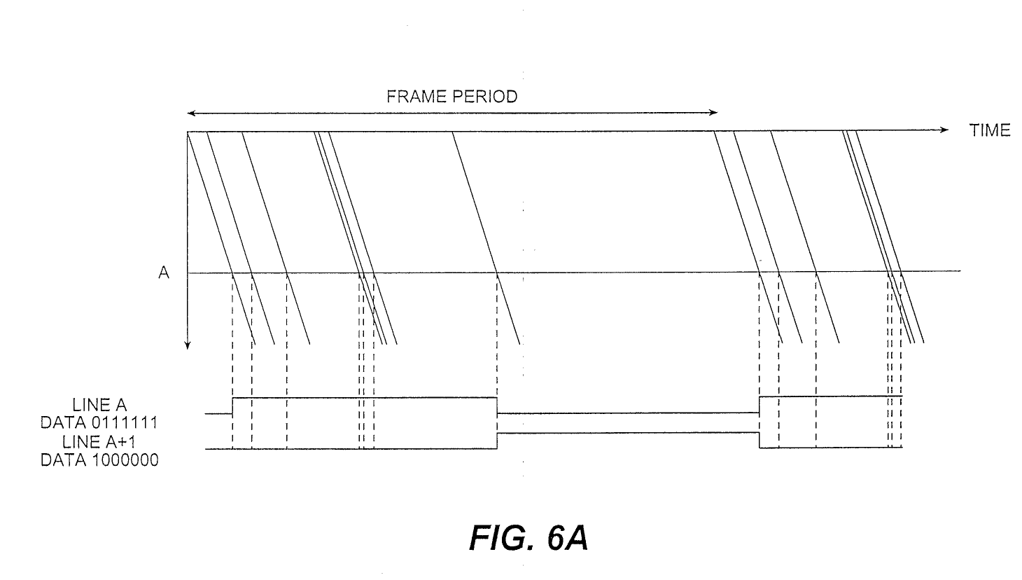

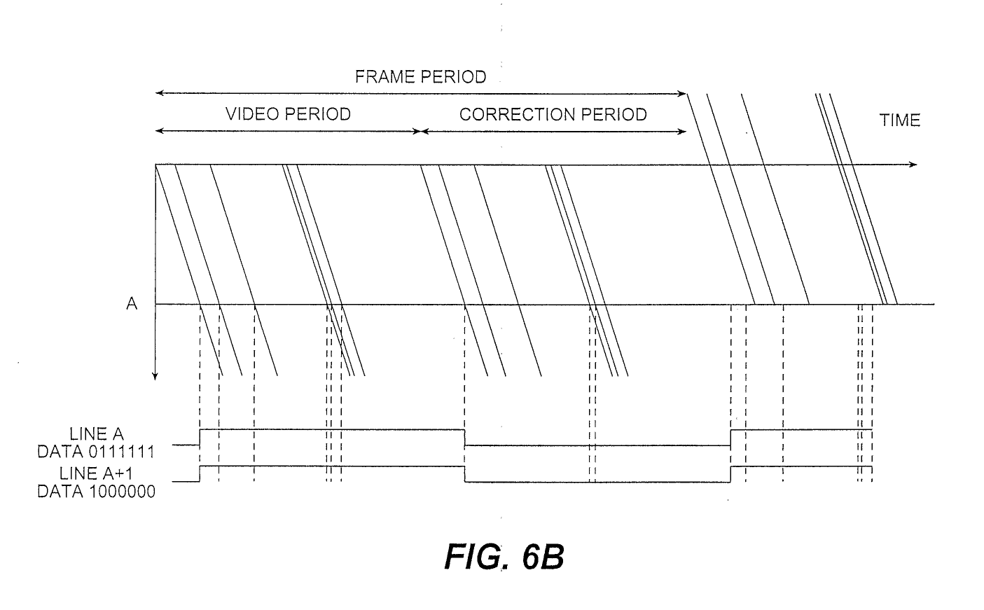

The above description briefly explains the gradation producible by a digitally driven display device. Meanwhile, when any image persistence results, the digitally driven display device must increase the brightness by an amount ΔL sufficient to compensate for the image persistence. FIG. 6 shows a conventional method for producing the gradation for image persistence correction.

For example, when data “63” in a 6-bit gradation is displayed, if the brightness ΔL reduced by the image persistence can be corrected by data “1”, data “63”+“1”=“64” will be finally produced as corrected data. For example, the data “64” can be produced according to the method shown in FIG. 6A. FIG. 6A shows a driving method for a digitally driven display device that can realize a 7-bit gradation. The 7-bit gradation can reproduce 127 gradation levels at maximum. Accordingly, in a case that the maximum value “63” of 6-bit video data cannot be reproduced due to deterioration of an organic EL element, the correction is feasible by using the 7-bit gradation display device.

For example, when video data of the line A is “63 (=0111111)” and video data of the line A+1 is “64 (=1000000)”e, a light emission pulse of the line A is opposite in phase to a light emission pulse of the line A+1. If such light emission pulses are produced as a result of correction, noise will be produced. This is commonly referred to as a “false contour”.

More specifically, when a viewer shifts their view from the line A to the line A+1, the viewer feels an increase in brightness due to switching from the light emission by the data “63” to a light emission by the data “64”. In other words, the light emission pulses bring visual effects different from their inherent effects. On the other hand, when a viewer shifts their view from the line A+1 to the line A, the viewer feels a decrease in brightness due to switching from no light emission by the data “64” to no light emission by the data “63”. In this case, the viewer feels a great difference (i.e., a difference between “127 (ON)” and “0 (OFF)”) in the brightness of a pixel, whereas the actual difference between the lines A and A+1 is small (i.e., only 1 in the gradation level). Accordingly, the viewer will perceive a displayed image as unnatural or uncomfortable, which may negate the effects of the correction. Hence, the present embodiment uses a correcting method shown in FIG. 6B.

FIG. 6B shows a method for driving for a digitally driven display device characterized in that one frame period is divided into a video period and a correction period. The video period is a period during which video data is directly displayed. The correction period is a period during which correction data is displayed.

According to the driving method shown in FIG. 6B, data “63” is displayed during the video period with respect to the lines A and A+1. However, displaying data “1” during the correction period is limited to the line A+1. Namely, video data “63” is displayed on the line A and video data “64” is displayed on the line A+1.

Unlike the correcting method of FIG. 6A, a light emission pulse of the line A and a light emission pulse of the line A+1 are not in the above opposite-phase relationship. Thus, no false contours are generated and intended correction effects can be obtained.

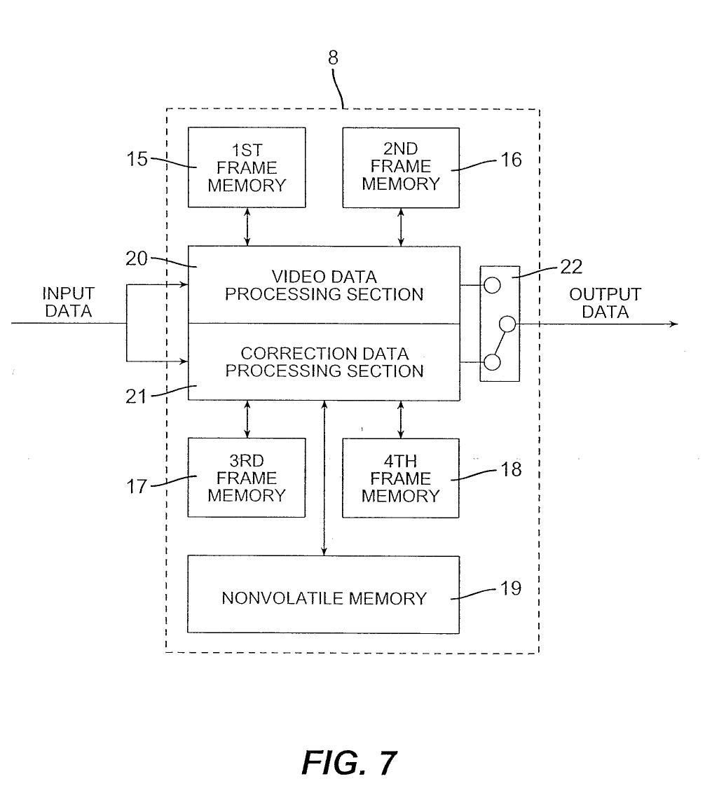

FIG. 7 shows an internal arrangement of the controller 8 that can realize the correction shown in FIG. 6B. The controller 8 includes a video data processing section 20, a correction data processing section 21, a multiplexer 22, first to fourth frame memories 15, 16, 17, and 18, and a nonvolatile memory 19.

Input data is entered into the video data processing section 20 and to the correction data processing section 21. The multiplexer 22 selectively outputs the video data produced from the video data processing section 20 or the correction data processing section 21. More specifically, the multiplexer 22 outputs the video data processed by the video data processing section 20 during the video period and outputs the video data processed by the correction data processing section 21 during the correction period, thereby realizing the driving method shown in FIG. 6B.

The video data processing section 20 produces video data of each sub frame at predetermined digital driving timing based on data of the first and second frame memories 15 and 16. The correction data processing section 21 produces correction data based on data of the third and fourth frame memories 17 and 18 and data of the nonvolatile memory 19. Each of the frame memories 15, 16, 17, and 18 is, for example, constructed from DRAM (Dynamic Random Access Memory) that can speedily read and write a great amount of data. The nonvolatile memory 19 is, for example, a NAND flash memory that has a large capacity and is non-expensive.

The video data processing section 20 produces the sub frame data in the following manner.

The input video data is temporarily stored in the first frame memory 15. Once the storing of video data for 1 frame is accomplished, random accessing of each bit of the video data of 1 frame is possible. As shown in FIG. 3, a reading operation starts from the first line to successively read data of a second bit. In some periods, such as the duration X, three lines are selected. In such a case, a successive data reading operation is performed as shown in FIG. 5. First, data of a second bit of the line N is read out. Then, data of a third bit of the line N-a is read out. Finally, data of a fourth bit of the line N-b is read out. While the video data of the first frame memory 15 is read out, video data of the next frame is stored in the second frame memory 16. Then, in a succeeding frame period, video data of the next frame is stored in the first frame memory 15 while the video data of the second frame memory 16 is read out. In this manner, the first and second frame memories 15 and 16 alternately repeat the processing for reading and storing the video data. The processed video data is supplied to the multiplexer 22.

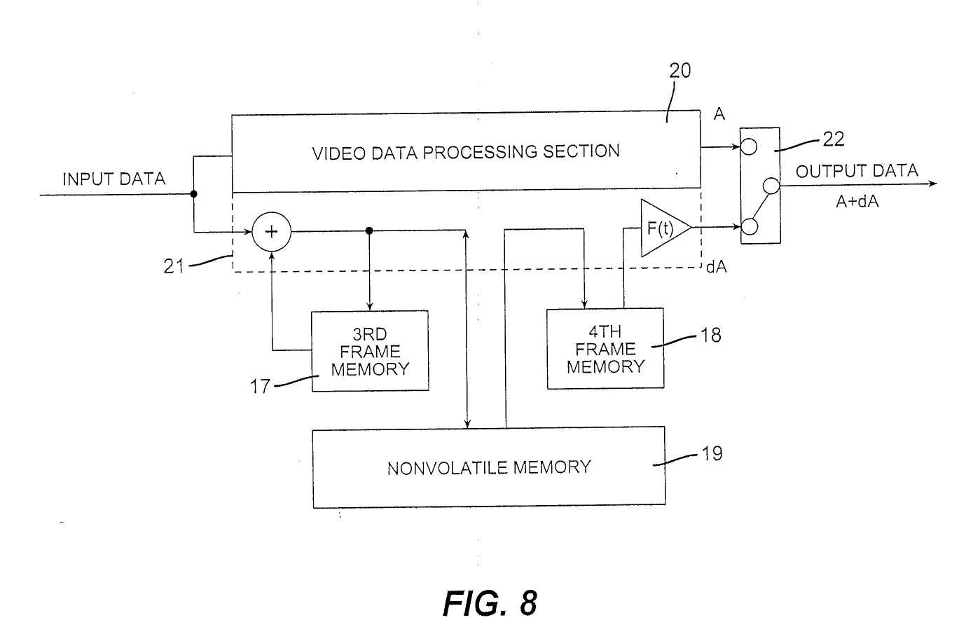

The correction data processing section 21 operates in the following manner. Performing the image persistence correction requires history of video data. FIG. 8 shows the flow of data processed in the correction data processing section 21.

In the initial stage immediately after starting use of the display device, the nonvolatile memory 19 holds initial history data of “0”. Once the display device begins operation, the video history data stored in the nonvolatile memory 19 is transmitted via the correction data processing section 21 and stored in the third frame memory 17 and the fourth frame memory 18. In general, the nonvolatile memory 19 is slow in access speed. Therefore, it is desirable to store the history data in the frame memories 17 and 18 that are speedily accessible.

The third frame memory 17 stores initial data “0” for each pixel in the initial stage after starting the use of the display device, and stores history data S (t-Δt, i, j) in an address A (i, j) of a corresponding pixel (i, j) at the time a significant period of time has passed from the beginning of the use of the display device, wherein “i” and “j” are positive integers and “t” is time during the operation of the display device.

In response to pixel-by-pixel entry of input video data D (t, i, j), the correction data processing section 21 accesses the third frame memory 17 to read the history data S (t-Δt, i, j) for 1 pixel from the address A (i, j) corresponding to the display position (i, j) of the input data. The readout history data S (t-Δt, i, j) is added to the input data D (t, i, j). Then, history data S (t, i, j)=D (t, i, j)+S (t-Δt, i, j) is produced and is stored (overwritten) in the same address A (i, j). The above processing is applied to all pixels of red (R), green (G), and blue (B) data. As a result, the third frame memory 17 stores, at time t, the history data S (t, i, j)=ΣD (t, i, j) of the data entered to each pixel during a period from time 0 to time t.

The history data S (t, i, j) is renewed, for example, by overwriting a relatively small size of data corresponding to pixels of several to several tens of frames into the corresponding address A (i, j) of the nonvolatile memory 19. In this manner, reducing the amount of information to be written at one time enables renewal of the nonvolatile memory 19 which has a relatively slow access speed.

The history data of the nonvolatile memory 19 is renewed during the operation of the display device. Thus, the fourth frame memory 18 accesses the nonvolatile memory 19 to read data of several pixels for several frames and renew the data. The history data of the fourth frame memory 18 read out and renewed immediately after the display device begins operation is subjected to correction data producing processing F(t), which is function of the entire operation time “t” of the display device, and is entered into the multiplexer 22. The multiplexer 22 outputs video data A supplied from the video data processing section 20 during the video period, and outputs video data dA supplied from the correction data processing section during the correction period. Thus, the multiplexer 22 produces video data A+dA. In other words, the correction video data dA compensates the reduction ΔL in brightness that is caused in the output of video data A shown in FIGS. 11A-11C.

At the time the operation of the display device ends, the latest history data stored in the third frame memory 17 is written into the nonvolatile memory 19. The nonvolatile memory 19 can hold the history data of all pixels even when the electric power is turned off. Repeating the above processing enables storage and renewal of the history data and use of the history data during the correction period.

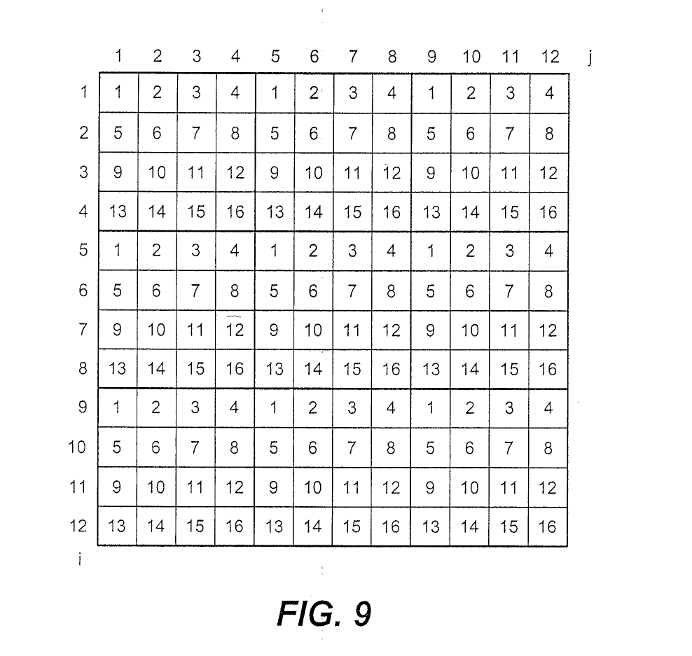

As the input video data does not normally change in frame units, it is possibly accumulating the input video data every several frames in the third frame memory 17. For example, as shown in FIG. 9, the history data of the third frame memory 17 can be renewed in units of 4×4 pixels that arrange a block.

When an updating order for replacing the data of the third frame memory 17 with the input video data is set as shown in FIG. 9, accumulating the history data stored in corresponding addresses in the third frame memory 17 is limited to pixel data of a position of “1” with respect to the frame 16*k+1, pixel data of a position of “2” with respect to the frame 16*k+2, and pixel data of a position of “16” with respect to the frame 16*k+16, when “k” is 0 or a positive integer. Controlling the updating order in this manner enables renewing each pixel in units of 16 frames. The data processing can thus be simplified and made faster.

To renew the history data in the nonvolatile memory 19 during the operation of the display device, it is possible to successively renew several pixels in units of a predetermined number of frames until the pixels are entirely renewed. However, limiting the renewal of the history data to pixels considered to be no more than slightly deteriorated enables simplifying and speeding up the processing and is accordingly effective in suppressing the image persistence.

For example, when the history data S (t-Δt, i, j) of a pixel (i, j) read out of the third frame memory 17 shows that an image having a higher luminous intensity has been continuously displayed, and the input video data D (t, i, j) of the display position is continuously entered as data having a higher luminous intensity, deterioration of the pixel will be minimal. Thus, it is desirable to renew the history data of the nonvolatile memory 19 and the fourth frame memory 18 as soon as possible, so that the renewal result can be promptly reflected on the display of an image. On the other hand, a pixel continuously displaying dark video data (having a lower luminous intensity) is relatively slow in deterioration speed and accordingly the renewal is not required so often. Hence, the entire processing can be simplified by executing the renewal of the history data only when there is a significant requirement for renewal of the data of the nonvolatile memory 19. Furthermore, to reflect the correction result, the fourth frame memory 18 must read the history data from the nonvolatile memory 19. In such a case, reading out only the data of pixels being subjected to the renewal of the nonvolatile memory 19 can simplify the processing.

The correction period shown in FIG. 6B can be set not only for the above-described image persistence correction but also for the processing for suppressing a false contour appearing on an image displayed during the video period.

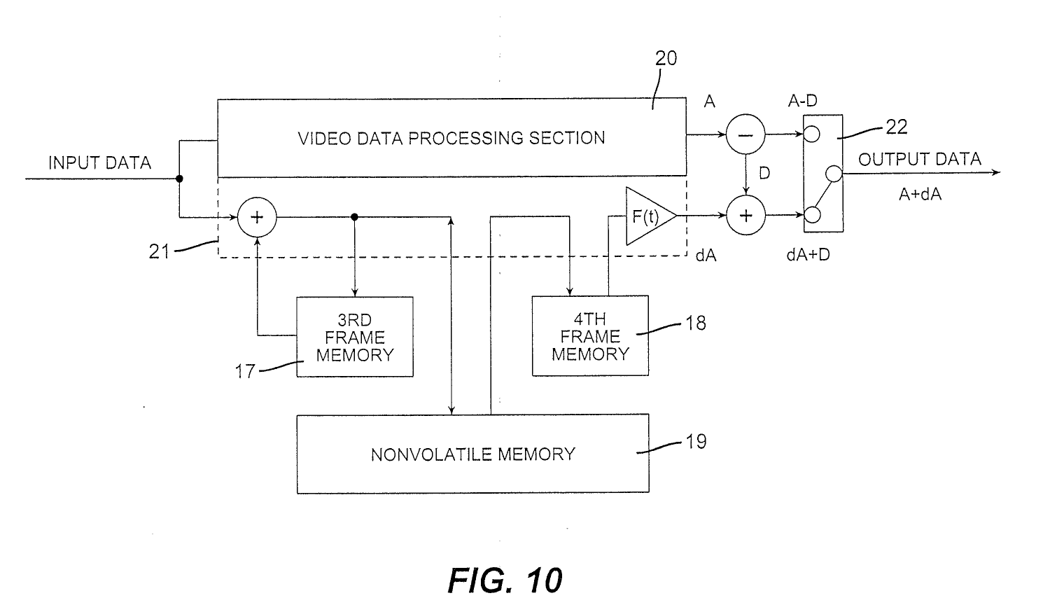

FIG. 10 shows an arrangement of the correction data processing section 21 that is capable of suppressing a false contour appearing during the video period. Video data A processed by the video data processing section 20 and correction data dA processed by the correction data processing section 21 are entered into the multiplexer 22. The multiplexer 22 selectively outputs the data in such a manner that the video data A is displayed during the video period and the correction data dA is displayed during the correction period. Thus, a luminous intensity A+dA is obtained.

When light emission pulses of neighboring data are mutually opposite in phase, a false contour appears on an image displayed during the video period. In such a case, data D for suppressing a false contour is subtracted from the video data A. The data is then added to the correction data dA. Thus, both the false contour and the image persistence can be corrected while the luminous intensity is maintained at the same level. For example, when the data “32” is adjacent to any one of neighboring data “31”, “30”, and “29”, the light emission pulses are opposite in phase because the bit string is “100000” for “32”, “011111” for “31”, “011110” for “30”, and “011101” for “29” and accordingly a false contour appears. When data D of “17” is, for example, selected under such conditions, the data displayed during the video period is “15”, “14”, “13”, and “12”, respectively. No false contour appears during the video period. Data “17”+dA is displayed during the correction period. The data D should be determined so that no false contour is produced by the data D+dA displayed during the correction period.

The controller 8 continuously monitors current flowing across all of the organic EL elements 9 involved in the active matrix array 2 during the video display period. Each organic EL element 9 has IV characteristics varying according to temperature. Hence, in a digitally driven display device that applies voltage to each organic EL element 9, the measured current value varies greatly according to the temperature. Such a change causes excessive current flowing across the organic EL element 9 and, as a result, deteriorates the organic EL element 9. Hence, the digitally driven display device requires appropriate means or a method that can suppress any change in current resulting from an increase in temperature.

The current value can be estimated in advance from the input data and the characteristics of the organic EL element 9. Therefore, monitoring a current value enables the controller 8 to judge whether or not the current then flowing is an appropriate value. When the current is larger than an estimated value, a significant influence of a temperature increase may be present. In such a case, the current can be equalized to the estimated value by reducing the brightness of the video data displayed during the video period and the correction data displayed during the correction period in the same manner.

For example, when the current is increased to a higher level equivalent to two times the estimated value, reducing each of the video data and the correction data to a half level enables preventing the current from excessively flowing while realizing an appropriate image persistence correction. Similar processing can be performed when the current decreases due to a temperature decrease. For example, when the current is reduced to a half level of the estimated value, the video data and the correction data should be doubled.

If the expanded data shown in FIG. 6A is used for the processing, a false contour will appear similarly. Accordingly, the first embodiment brings the effect of appropriately maintaining the image quality while suppressing adverse influence of a temperature change.

### Second Embodiment

The image persistence is a phenomenon that deteriorates an organic EL element but also gives adverse influence to a drive transistor. Especially, when compared with a low-temperature polysilicon TFT, an amorphous silicon TFT is characterized in that shifting of threshold value Vth advances within a very short time.

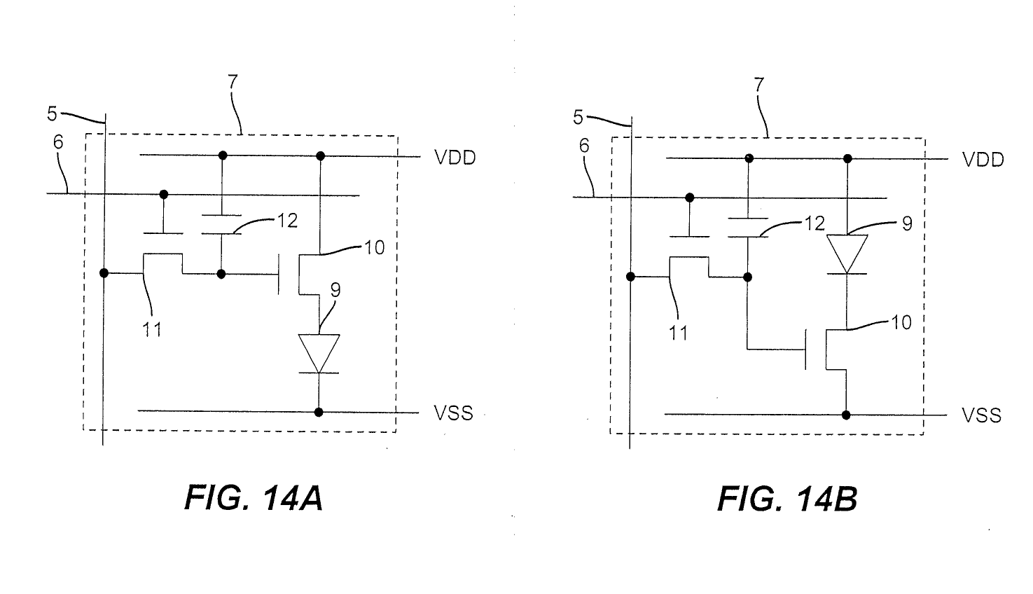

The second embodiment of the present invention uses a similar principle in correcting deterioration of a drive transistor. A method for correcting the deterioration of a drive transistor according to the second embodiment will be described hereinafter. FIG. 14A shows one example of the pixel circuit 7. FIG. 14B shows another example of the pixel circuit 7. The pixel circuit 7 of FIG. 14A differs from the pixel circuit 7 of FIG. 2 in that an n-channel transistor is used. According to the pixel circuit 7 of FIG. 14B, an anode of the organic EL element 9 is connected to the power line and maintained at the voltage VDD and a cathode is connected to a drain terminal of the drive transistor 10. A source terminal of the drive transistor 10 is connected to the VSS terminal and maintained at the voltage VSS. As a source potential of the drive transistor 10 is fixed at the voltage VSS, the current flowing across the organic EL element 9 is controlled based on a gate potential of the drive transistor 10. On the other hand, according to the pixel circuit 7 of FIG. 14A, a source potential of the drive transistor 10 is not fixed and accordingly the current flowing across the organic EL element 9 is controlled based on a difference between the gate potential of the drive transistor 10 and an anode potential of the organic EL element 9.

The pixel circuit 7 of FIG. 14A can be formed using a process of an organic EL having a common cathode, as in the pixel circuit 7 of FIG. 2. However, controlling the pixel circuit 7 is problematic because the source potential of the drive transistor 10 is not fixed. On the other hand, the pixel circuit 7 of FIG. 14B can be easily controlled because the source potential of the drive transistor 10 is fixed. However, the pixel circuit 7 of FIG. 14B must be formed by using an organic EL process having a common anode. Thus, it is necessary to develop a new device. In either type, the pixel circuit 7 of the present embodiment can be realized.

For example, the data driver 3 can be constructed from a 6-bit data driver IC according to which producible data are limited to 64 levels (in gradation). When data “64” is necessary for realizing the image persistence correction, the 6-bit data driver IC cannot produce the data “64”. Accordingly, an expensive 7-bit or 8-bit data driver IC is required to produce a larger number of data.

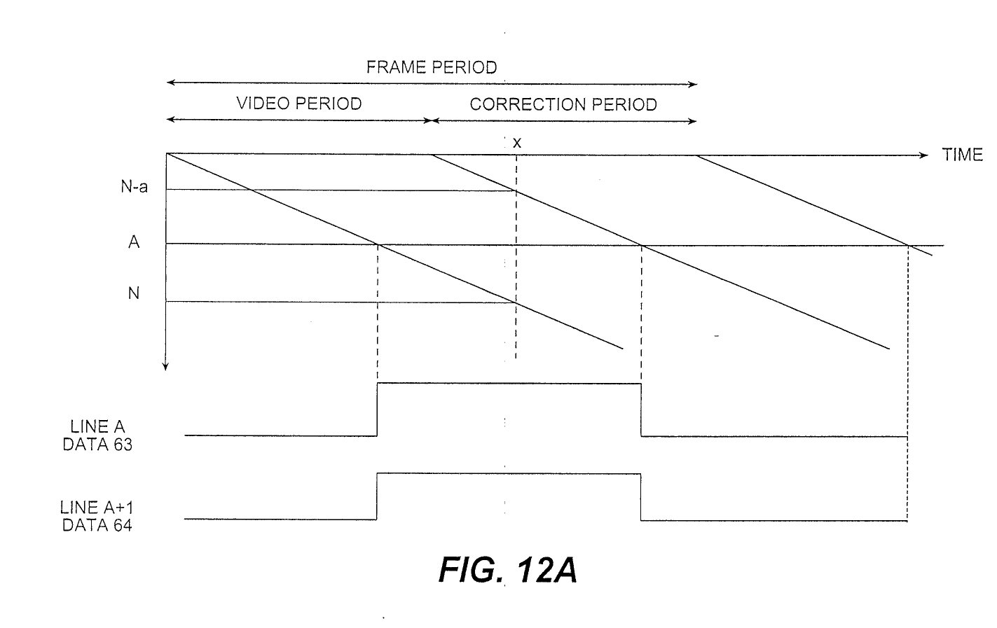

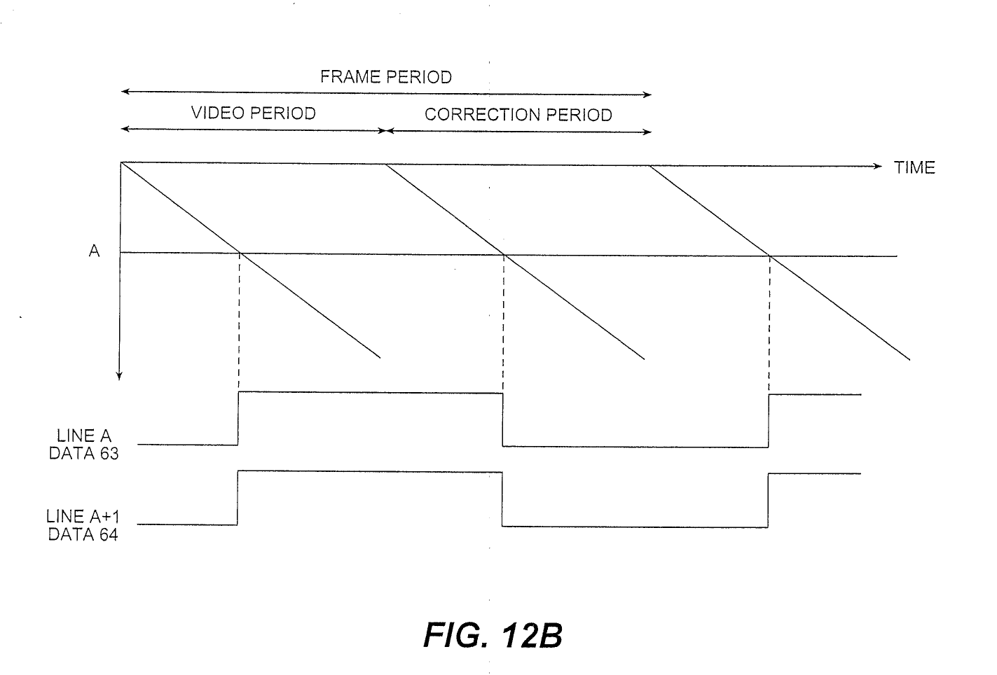

However, using the driving method shown in FIGS. 12A and 12B enables producing data exceeding level 63 even if a 6-bit driver is used.

According to the driving method shown in FIG. 12A, a frame period is divided into a video period and a correction period. During the video period entered video data is displayed, while during the correction period correction data for correcting image persistence is displayed. First, in the video period, entered video data is successively written, from the first line, into the pixel circuit of FIG. 14A or FIG. 14B. Subsequently, in the correction period, correction data is written, from the first line, into a pixel circuit holding the video data.

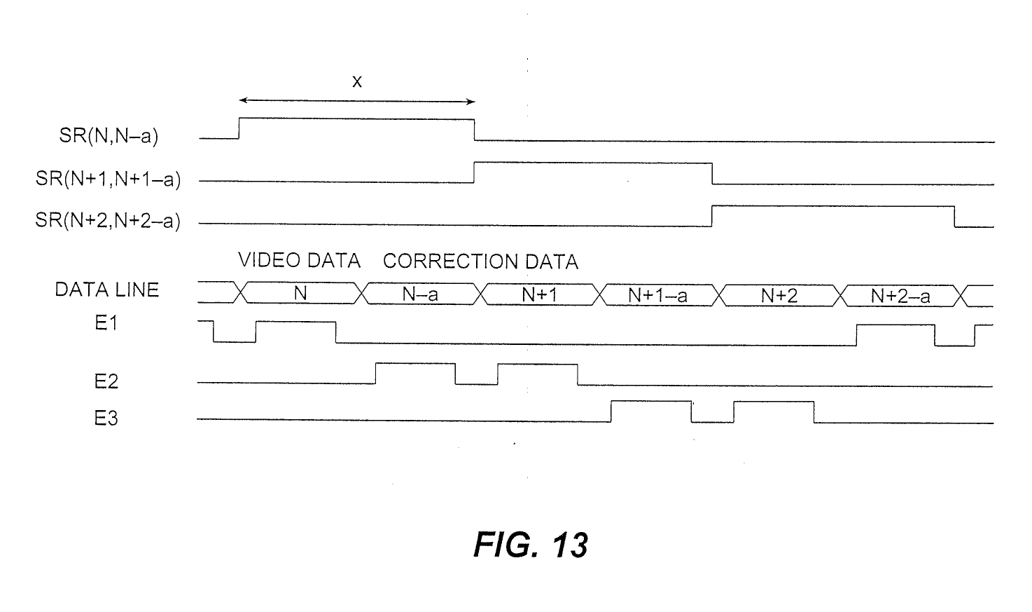

This operation is described hereinafter with respect to the lines A and A+1. It is now assumed that each of the lines A and A+1 displays the same video data “63”. The line A+1 requires correction of “1” to display the data “64”. The lines A and A+1 are not different from each other in displaying the data “63” in the video period. Only the line A+1 requires the correction and accordingly correction data “1” is displayed in the correction period. To realize this driving method, the gate driver shown in FIG. 4 is used and the data and the enable lines E1, E2, and E3 are controlled as shown in FIG. 13. In FIG. 12A, it is necessary to select, in the duration X, the line N and the line N-a to write video data and correction data respectively.

As understood from the arrangement of gate driver 4 shown in FIG. 4, the N line (N=3*n+1) is selected by the enable line E1 and the N-a line (N-a=3*n+2) is selected by the enable line E2. The duration X is divided into two periods. In the first half of the duration X, video data of the line N is output to the data line 5 while the enable line E1 is activated to write the video data into a pixel of the line N. In the second half of the duration X, correction data of the line N-a is output to the data line 5 while the enable line E2 is activated to write the correction data into a pixel of the line N-a. Subsequently, the line N+1 is selected by the enable line E2 to write video data of the line N+1 supplied to the data line 5 into a pixel of the line N+1. The line N+1-a is selected by the enable line E3 to write correction data of the line N+1-a supplied to the data line 5 into a pixel of the line N+1-a. Repeating this operation enables producing light emission pulses of the lines A and A+1 shown in FIG. 12A. Thus, intended image display can be realized by using a 6-bit driver IC, while image persistence can be appropriately corrected. On the data line shown in FIG. 13, the ratio of the video data and the correction data during the duration X is arbitrary. It is therefore possible to increase the time for supplying video data to reliably write the video data into a pixel.

A driving method as shown in FIG. 12B can be also used. Unlike the driving method of FIG. 12A according to which writing of all lines requires an entire frame period, the driving method of FIG. 12B is characterized in that video data of all lines are written during a first half of the frame period and correction data of all lines are written during a second half of the frame period. The driving method of FIG. 12B does not require the control shown in FIG. 13. The video data and the correction data are written, at a doubled speed, into a pixel of each line.

Either of the above methods can be controlled by the controller shown in FIG. 7. According to the driving method of FIG. 12A, both the video data and the correction data are output to the data line 5 during the duration X. The multiplexer 22 switches the video data and the correction data at intervals equal to the duration X. In this case, holding one complete frame of video data is unnecessary. Thus, using both the first frame memory 15 and the second frame memory 16 is unnecessary. According to the driving method of FIG. 12B, writing of the video data must be accomplished during a half frame period. Thus, it is necessary to hold one frame of video data in the first and second frame memories 15 and 16 and perform a reading operation at a doubled speed. During the video period, the multiplexer 22 outputs video data processed by the video data processing section 20. During the correction period, the multiplexer 22 outputs correction data processed by the correction data processing section 21. The correction data processing of the second embodiment is identical with the correction data processing of the first embodiment. Application of the above-described method according to the second embodiment is not limited to amorphous silicon TFTs. Accordingly, the method of the second embodiment is applicable to the pixel circuit shown in FIG. 2 using a low-temperature polysilicon TFT having relatively stable element characteristics, or other self-luminous type display devices such as CRTs (Cathode Ray Tubes), PDPs (Plasma Display Panels), or SEDs (Surface Conduction Electron Emitter Displays).

### Third Embodiment

Outputting video data instead of outputting correction data or outputting video data in addition to correction data enables displaying a total of 64 or more levels of gradation using, for example, a 6-bit data driver. In a case that only the display period is used, the display of the 6-bit data driver is limited to 64 gradation levels. On the other hand, using the correction period as an extended video period enables realizing a 127-gradation display as a result of addition of 64 gradation levels and 63 gradation levels.

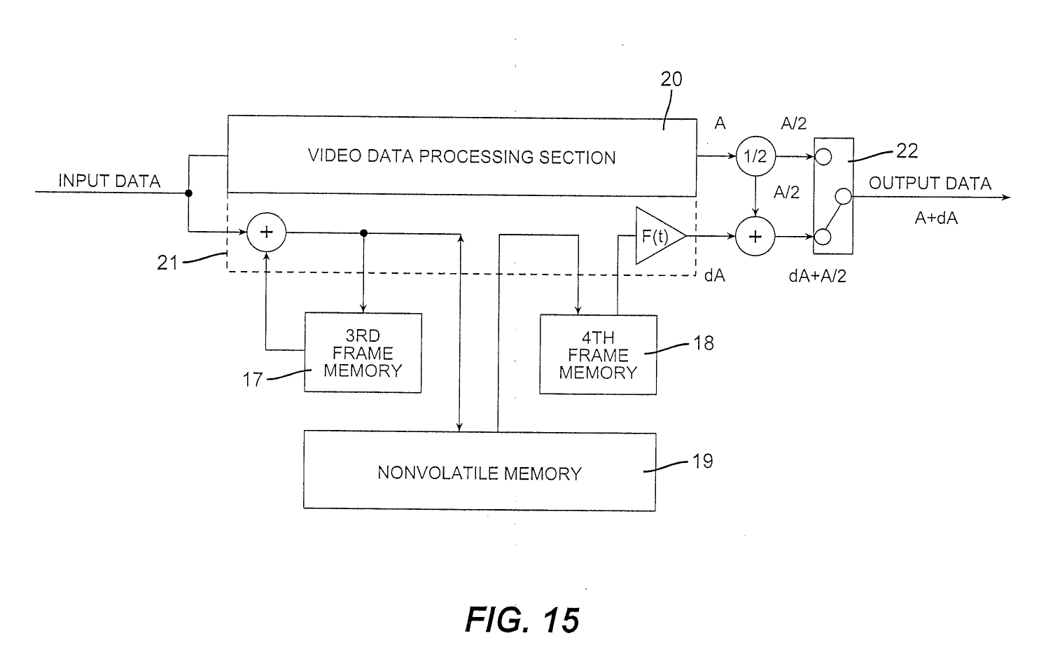

As shown in FIG. 15, video data A constructed from data exceeding 6 bits (e.g., 7-bit data) is converted into two sets of video data A/2. One video data set A/2 is displayed during the display period. The other video data set A/2 is added with correction data dA and displayed during the correction period. As the video data A/2 is displayable as 6-bit data, no data is lost, even when the video data is divided into two sets.

To realize this, a frame memory is used to store one frame of video data. The video data stored in the memory is converted into half data and output during the video period. Subsequently, during the correction period, the data of the frame memory is similarly converted into half data and added with correction data to output added data in this period. The driving method is similar to that shown in FIG. 12A and FIG. 12B.

According to the method of the third embodiment, when a device is relatively slow in brightness deterioration, substantially no light emission occurs during the correction period. Therefore, the correction period can be effectively used.

The above-described method according to the third embodiment can be applied to a non-light emitting display device such as LCD (Liquid Crystal Display) in view of the capability of increasing the gradation levels.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

The invention has been described in detail with particular reference to certain preferred embodiments thereof, but it will be understood that variations and modifications can be effected within the spirit and scope of the invention.

### PARTS LIST

A image
B image
C image
E1 enable line
E2 enable line
E3 enable line
N-a line
T0 display period
T1 display period
T2 display period
T3 display period
T4 display period
T5 display period
1 display device
2 active matrix array
3 data driver
4 gate driver
5 data line
6 gate line
7 pixel circuits
8 controller
9 organic EL element
10 drive transistor
11 gate transistor
12 capacitor
13 shift registers

### PARTS LIST CONT'D

14 enable circuit
15 frame memories
16 frame memories
17 frame memories
18 frame memories
19 nonvolatile memory
20 video processing section
21 correction data processing section
22 multiplexer

1. A display device comprising:
a display section including a plurality pairs of an electro-optical element and a pixel section which are disposed in a matrix pattern, the pixel section controlling a light intensity of the electro-optical element based on a selection signal of a gate line and a data value of a data line;
a data driver for supplying the data value to the data line;
a gate driver for supplying the selection signal to the gate line; and
a controller including a video data processing section for outputting video data to each pixel section in accordance with an externally entered video signal, a correction data processing section for calculating and outputting correction data based on the video data supplied to each pixel section or based on output history of the video data, and a multiplexer for selectively outputting the data in such a manner that the video data is displayed during a predetermined video period and the correction data is displayed during a predetermined correction period, wherein addition of the video period and the correction period is equal to a display period of one frame in the display section.

2. The display device according to claim 1, wherein the electro-optical element is a light emitting element.

3. The display device according to claim 1, wherein the pixel section comprises:
a light emitting element;
a drive transistor for controlling light emission of the light emitting element based on the data value supplied to the data line; and
a gate transistor for controlling the data value of the data line supplied to the drive transistor based on the selection signal supplied to the gate line.

4. The display device according to claim 3, wherein the data value supplied to the data line includes a data value for turning on the drive transistor and a data value for turning off the drive transistor.

5. The display device according to claim 3, wherein the data value supplied to the data line includes data values for producing a plurality of current values from the drive transistor.

6. The display device according to claim 1, wherein the gate driver comprises:
a plurality of shift registers, each provided for a predetermined line, for transferring selected data;
a plurality of enable circuits, each provided for a predetermined line, for enabling the selected data; and
a total of n (n is an integer greater than or equal to 2) enable control lines for controlling the enable circuits,
wherein a group of enable circuits, disposed at intervals of n lines, are connected to a same enable control line.

7. The display device according to claim 6, wherein:
the gate driver selects a gate line by activating one non-active enable control line from the n enable control lines, when selected data are input to lines mutually different in a remainder resulting from a division of P/n, where P is a total number of gate lines, and
the data driver outputs video data of the gate line selected by the enable control line.

8. The display device according to claim 1, wherein the multiplexer outputs the video data produced from the video data processing section during the video period and outputs the correction data produced from the correction data processing section during the correction period.

9. The display device according to claim 6, wherein the multiplexer outputs the video data produced from the video data processing section during a period selected, by the enable control line, for writing the video data, and outputs the correction data produced from the correction data processing section during a period selected, by the enable control line, for writing the correction data.

10. The display device according to claim 1, wherein selection and output of the multiplexer is performed in such a manner that part of the video data produced from the video data processing section is displayed during the video period and the rest of the video data and the correction data produced from the correction data processing section are displayed during the correction period.

11. The display device according to claim 1, wherein selection and output of the multiplexer is performed in such a manner that part of the correction data produced from the correction data processing section is displayed during the correction period and the rest of the correction data and the video data produced from the video data processing section are displayed during the video period.

12. The display device according to claim 1, wherein the correction data processing section calculates a cumulative value of luminous intensity in each pixel section, and calculates the correction data for the pixel circuit with reference to the cumulative value.

13. The display device according to claim 12, wherein
the correction data processing section includes a volatile memory,
each pixel section is classified into one of a plurality of updating order categories, and
the cumulative value calculated for each pixel section is divided sequentially in time for each updating order category and stored in the volatile memory.

14. The display device according to claim 12, wherein
the correction data processing section includes a volatile memory and a nonvolatile memory, and
the cumulative value calculated for each pixel section and stored in the volatile memory is renewed in the nonvolatile memory at timing different from the timing of the volatile memory.

15. The display device according to claim 12, wherein:
the correction data processing section includes a volatile memory and a nonvolatile memory, and
at least one of the volatile memory and the nonvolatile memory is renewed based on a present luminous intensity of a pixel section and the cumulative value calculated for the pixel section when the luminous intensity is high and a light emission period is long in the pixel section.

16. The display device according to claim 1, wherein:
the controller includes a current monitor for measuring a current value supplied to the display section,
the video data processing section corrects the video data based on a measurement result of the current monitor, and
the correction data processing section corrects the correction data based on the measurement result of the current monitor.

17. The display device according to claim 2, wherein:
an anode of the light emitting element is connected to a first power line via a drain-source of the drive transistor,
a cathode of the light emitting element is connected to a second power line,
a gate of the drive transistor is connected via a drain-source of the gate transistor to the data line and also connected via a capacitor to the first power line, and
a gate of the gate transistor is connected to the gate line.

18. The display device according to claim 2, wherein:
an anode of the light emitting element is connected to a first power line,
a cathode of the light emitting element is connected via a drain-source of the drive transistor to a second power line,
a gate of the drive transistor is connected via a drain-source of the gate transistor to the data line and also connected via a capacitor to the first power line, and
a gate of the gate transistor is connected to the gate line.
